(19) United States
(12) Patent Application Publication
(10) Pub. No.: US 2002/0185608 A1
(43) Pub. Date: Dec. 12, 2002

(54) Measuring device and a method for determining at least one luminescence, or absorption parameter of a sample

(76) Inventor: Manfred Wieser, Salzburg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/158,909

(22) Filed: Jun. 3, 2002

(30) Foreign Application Priority Data
Jun. 6, 2001 (AT) A 882/2001

(51) Int. Cl. G01N 21/64

(52) U.S. Cl. 250/458.1

(57) ABSTRACT

The invention relates to a method and measuring device for determining at least one luminescence, fluorescence, or absorption parameter of a sample, including an excitation light source supplying the excitation radiation directed onto the sample, a detector unit for detection of the emission radiation (i.e., the radiation to be measured) given off by the sample, and an acousto-optical tunable filter (AOTF) being provided in the radiation path of the excitation radiation and/or in the radiation path of the emission radiation. The ultrasonic oscillations of the acousto-optical filter are excited by a high-frequency oscillator, which is furnished with a unit for amplitude modulation in the form of a rectangular, Gaussian, Hann, or Hamming window, thus providing an optical switch with switching times in the μsec range.

### BACKGROUND OF THE INVENTION

The present invention relates to a measuring device and a method for determining at least one luminescence, fluorescence, or absorption parameter of a sample, the excitation radiation supplied by a radiation source being directed onto the sample and the emission radiation emitted by the sample being detected by a detector unit, excitation radiation and/or emission radiation passing through an acousto-optical tunable filter (AOTF).

### DESCRIPTION OF PRIOR ART

In this context a detection unit has been disclosed in EP 0 841 557 A2 for the detection of sample specimens provided in so-called microplates. The detection unit includes a broad-band light source supplying the excitation radiation. Between the light source and the sample a tuning section is provided by means of which the wavelength required for excitation can be set or selected from the broad-band excitation radiation. After passage through a focusing optical element the excitation radiation will arrive at the sample and induce it to emit radiation. The emission radiation is transmitted via a reflection geometry to a first detector, or via an absorption geometry to a second detector. Both detectors are connected to an evaluation unit. An imaging optical element and a second tuning section are provided in front of each individual detector for setting or selecting the emission radiation reaching the first or second detector.

The tuning section in EP 0 841 557 A2 may be implemented in different ways. Possible variants fall into four categories, i.e., dispersive elements, refractive elements, inter-ferometric elements, and filters. Optical gratings may be used, for example, where the wavelength is selected by rotating the grating and focusing onto an aperture. Alternatively, two filter wheels may be used, which are positioned one behind the other in the radiation path and include a low-pass and a high-pass filter selecting a narrow band of wavelengths. By turning the filters about their radial axis the desired wavelength may be tuned within a given range.

The disadvantage of the above variants, all of which feature movable optical components, is their complex design and the comparatively long switching and setting times. Moreover, such mechanical systems are prone to operational failure and cannot be universally employed.

As concerns the tuning section, EP 0 841 557 A2 also makes mention of acousto-optical filters that do not have mechanically movable parts.

Such acousto-optical tunable filters or AOTF have been described in conjunction with a fluorescence measuring device in WO 00/39545 A1. In this measuring device the light of a monochromatic light source is transmitted through an acousto-optical filter onto the sample whose emission radiation is directed onto two detecting units through the same acousto-optical filter. In this way excitation radiation and emission radiation meet inside the acousto-optical filter, passing through the filter in opposite directions. The emission radiation exiting from the acousto-optical filter forms two partial beams which are polarized orthogonally relative to each other, each beam reaching one of the two detector units.

The AOTF is an optical (narrow-band) filter, where electrically excited ultrasonic oscillations produce periodic density fluctuations in a birefringent crystal (e.g., TeO₂). These oscillations in the crystal are generated by an externally positioned ultrasonic transducer (piezocrystal), and will pass through the crystal and induce spatially periodic density fluctuations diffracting the incident light by forming a Bragg grating.

In U.S. Pat. No. 4,663,961 A and U.S. Pat. No. 4,490,845 A analyzing systems are disclosed, which are provided with an acousto-optical filter either in the radiation path of the excitation radiation or that of the emission radiation. As described in U.S. Pat. No. 4,663,961 A, the acousto-optical filter is frequency modulated via a high frequency oscillator. By the known analyzers, however, the rapid switching times desired with some applications cannot be achieved.

In U.S. Pat. No. 5,357,097 A, a method and apparatus for controlling acousto-optical filters are disclosed. The ultrasonic oscillation for the AOTF is excited by means of a high-frequency oscillator provided with a unit for frequency and amplitude modulation. The ideas put forth in this context do not refer to measuring equipment or methods for determining a luminescence, fluorescence, or absorption parameter of a sample, however.

### SUMMARY OF THE INVENTION

Based on the detection and fluorescence-measuring systems described above, it is the object of the present invention to propose a measuring method as well as a compact and reliable measuring device without mechanically movable components, which should be characterized by short switching times and variable bandwidths of the AOTF.

According to the invention this object is achieved by providing that the excitation frequency of at least one acousto-optical filter is amplitude-modulated, an amplitude modulation in the form of a rectangular, Gaussian, Hann, or Hamming window being applied to the excitation frequency in order to obtain an optical switch with switching times in the μsec range. If the applied high frequency is switched on or off (or rather, if the amplitude is modulated correspondingly), the AOTF acts as an optical switch with switching times in the μsec range, the high-frequency envelope (=time window) determining the properties of the switch.

In the frequency domain these window functions have different properties regarding filter width and the occurrence of sidelobes. The AOTF permits amplitude modulation using all of these window functions, the choice of the suitable window depending on the respective object of the application.

The high-frequency generator comprises a suitable oscillator and amplifier, so that frequency jumps may be performed within the shortest possible time without a phase change.

When a frequency jump occurs, the optical switching time (shifting of the passing curve into a different range of wavelengths) is essentially determined by the period of time required by the ultrasonic wave to pass through the AOTF crystal. For the crystal materials and dimensions of crystals used this period is a few μsecs. As a consequence it will be possible to traverse even larger ranges of wavelengths without time loss due to mechanical processes.

As long as the AOTF is employed in the linear range, two or more HF signals may be applied, i.e., two or more wavelengths may be analyzed simultaneously. All measuring processes to be discussed on the following pages will thus permit three-dimensional spectral scans to be performed more or less in real time.

By application of an amplitude modulation the AOTF further offers the possibility of modulating the light beam with a relatively high modulation frequency. In this way a sensitive PLL process (lock-in-amplifier) may be employed for signal processing and detection.

A measuring device for determining at least one luminescence, fluorescence, or absorption parameter of a sample, including an excitation light source supplying the excitation radiation directed onto the sample, and a detector unit for detection of the emission radiation given off by the sample, an acousto-optical tunable filter (AOTF) being provided in the radiation path of the excitation radiation and/or in the radiation path of the emission radiation, is characterized according to the invention in that a high-frequency oscillator is provided for excitation of the ultrasonic oscillations for the acousto-optical filter, which oscillator includes a unit for amplitude modulation configured as a rectangular, Gaussian, Hann, or Hamming window, so that an optical switch with switching times in the μsec range will be obtained.

The minimum pass bandwidth of an AOTF is a quantity that usually depends on variables such as crystal material, crystal structure, temperature, etc., and is not subject to electric influences. Larger bandwidths conventionally can be measured only by integrating over several measurements at adjacent, and preferably overlapping bands of wavelengths. In accordance with the invention the bandwidth of the acousto-optical filter may be set or varied by a frequency modulation of the excitation frequency, i.e., the pass characteristic is widened by applying a frequency modulation to the HF signal.

In a preferred variant of the invention the intensities of two extraordinary beams of the acousto-optical filter positioned in the emission radiation, which are polarized orthogonally relative to each other, are simultaneously measured and the depolarization of the emission radiation is computed from the ratio of these intensities.

The ordinary beam is blocked either by apertures or crossed polarizers positioned in the radiation path before and after the AOTF. The two remaining, extraordinary beams have polarization planes that are orthogonal to each other. If these two beams are analyzed with separate detectors, the energies or intensities of the two beams may be determined simultaneously (application: Polarization Fluorescence).

### BRIEF DESCRIPTION OF THE DRAWINGS

The invention will now be explained in more detail with reference to the accompanying drawings, wherein

FIG. 1 shows the functional principle of an AOTF,

FIG. 2 is a diagram showing the intensity of ordinary beam O and the two extraordinary beams A1 and A2 as a function of wavelength λ,

FIG. 3 shows the schematical design of a measuring device according to the invention,

FIG. 4 illustrates the principle of the measuring process according to the invention by means of transmission fluorescence,

FIG. 5 illustrates the principle of the measuring process according to the invention by means of time resolved fluorescence.

### DETAILED DESCRIPTION OF THE PREFERRED EMBODIMENT

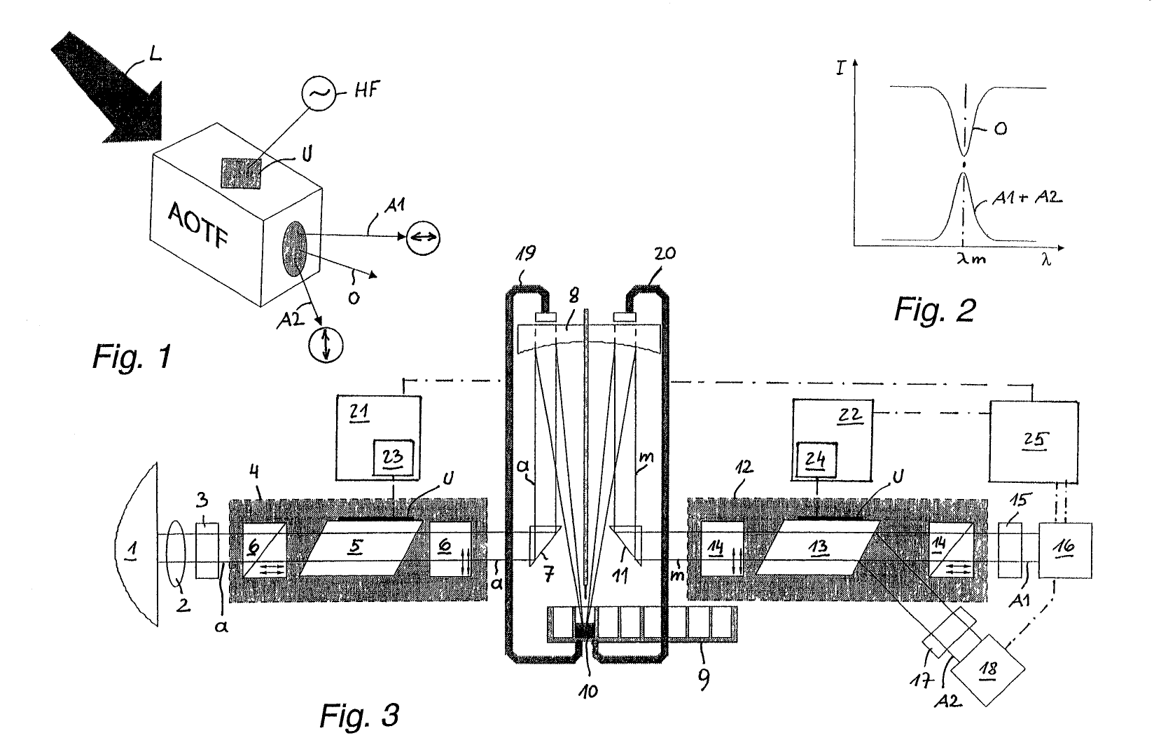

In FIGS. 1 and 2 the functional principle of an AOTF is presented. Incident, unpolarized, broad-band light L is splitted into three beams (ordinary beam O and the two orthogonally polarized, extraordinary beams A1 and A2), by applying a high frequency HF to the ultrasonic transducer U.

FIG. 2 shows the intensity maximum for the two extraordinary beams A1 and A2 at the medium wavelength λₘ depending on the applied high frequency, and an intensity minimum for the ordinary beam O.

Selection of the beam desired for the respective application is made either by adding crossed polarizers before and after the AOTF or simply by blocking the undesirable beams.

The exemplary measuring device of FIG. 3, which is designed for determining at least one luminescence, fluorescence, or absorption parameter of a sample, has a broad-band excitation light source 1 supplying excitation radiation a. The excitation radiation a emitted by a light source 1 passes through a focusing optical element 2 and a blocking filter 3, and enters an excitation unit 4. Excitation unit 4 comprises an acousto-optical filter 5 and polarizers 6 both before and after the filter 5. After leaving the excitation unit 4 the beam passes a deflecting mirror or deflecting prism 7 and another deflecting or focusing mirror 8 before arriving at the sample 10 positioned in a microplate 9. The emission radiation m emitted by the sample 10 passes the focusing mirror 8 and a deflecting mirror or deflecting prism 11 before reaching an emission unit 12. Like the excitation unit 4 the emission unit 12 is furnished with an acousto-optical filter 13 and two polarizers 14. The extraordinary beam A1 arrives via a blocking filter 15 at a first detector 16, while the extraordinary beam A2 arrives via a blocking filter 17 at a second detector 18. The radiation path described above illustrates a top reading of the sample 10; a bottom reading of the sample through the bottom of the microplate 9 would also be possible by means of optical fiberguides 19 and 20.

If a monochromatic lightsource is used the excitation unit 4 may be dispensed with. Instead of the microplate 9 other vessels made of glass, silica or plastic could be used, such as Petri dishes, cells or tubes. At least one of the two AOTF in the excitation radiation a or emission radiation m has a high-frequency oscillator 21 or 22 acting on the ultrasonic transducer U, which oscillator comprises a unit 23 or 24 for frequency and/or amplitude modulation. Numeral 25 refers to a control and evaluation unit of the measuring device.

By means of the measuring device according to FIG. 3 a variety of measuring processes may be performed using one and the same configuration. Examples of applications are given below.

### (1) Fluorescence

Intensity Fluorescence

The excitation radiation a emitted by a broad-band light source 1 is passed by suitable optical means (apertures, lenses, mirrors, prisms, optical fibers) through a narrow-band acousto-optical filter 5, by means of which a defined wavelength is selected from the available color spectrum of the light source 1.

The excitation radiation a is applied to the sample 10 for a very short period of time (a few μsecs) in order to excite the fluorophore contained therein, using the acousto-optical filter 5 as a fast optical switch. After a latency of approximately 2 μsecs the fluorophore will begin to emit radiation m of a longer wavelength. The emission period is in the region of a few μsecs to msecs.

The samples 10 may be liquid, solid, or gaseous, and are contained in vessels 9 of silica, glass or plastic (microplates, Petri dishes, cells, tubes, etc.).

The emission radiation m is passed by suitable optical means (apertures, lenses, mirrors, prisms, optical fibers) through a narrow-band acousto-optical filter 13 (emission filter) selecting the wavelength of interest. The respective light signal will be passed on to an extra-sensitive detector 16, where it is converted into an electrical signal. In the instance of polarization fluorescence measurement a second, independently operating detector 18 will be used in addition to the first one.

Suitable detectors 16, 18 mainly are secondary electron multipliers, or semiconductor diodes. The electrical signal is further processed in the electronic circuits of the evaluation unit 25 following the detectors.

In addition to the method described above fluorescence can be measured by other methods of importance, such as

Transmission Fluorescence

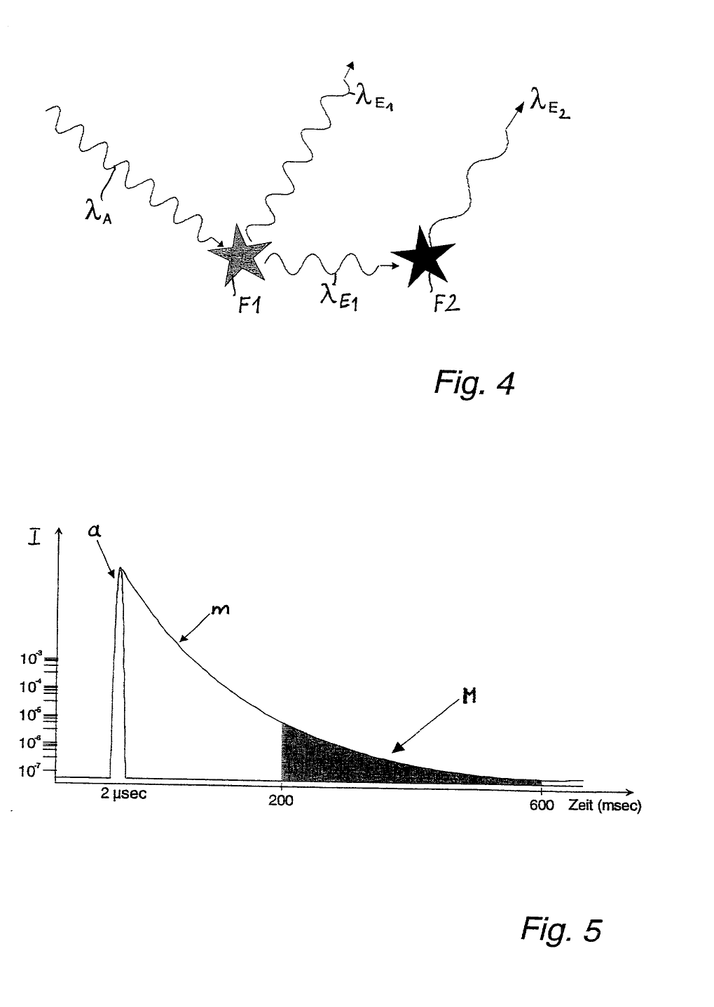

In this instance the ratio of two emission wavelengths λ_{E1} and λ_{E2} is of interest, as is shown in FIG. 4. A fluorophore F1 excited by λ_{A} emits light at the excitation wavelength of a second fluorophore F2. By measuring both emitted signals the ratio of the two active fluorophores F1 and F2 may be determined. The excitation wavelength λ_{A} is supplied by an AOTF.

In this case the critical factor is the switching time of the emission-side AOTF between the two wavelengths λ_{E1}, and λ_{E2}, as both emission signals should be measured practically simultaneously.

With the use of an AOTF switching times of a few μsecs will be possible. As a consequence, the change in wavelength can be implemented faster by several orders of magnitude compared to conventional, mechanically actuated interference filters or diffraction gratings.

Time-Resolved Fluorescence

In this case the curve of the emitted energy as a function over time is of interest. Some fluorophores, especially such carrying ionized lanthanides (e.g., europium Eu³⁺) will emit a fluorescence signal for a comparatively long time after excitation. For example, a measuring period of 400 ms may be required, which must be initiated exactly 200 ms after excitation. Corresponding data are given in the diagram of FIG. 5, where the intensity I of excitation radiation a and emission radiation m is plotted over time. Measured values are obtained by integration over region M.

The main problem with this application is the occurrence of very high light energies upon excitation, where cells, solvents, etc. generate a considerable amount of secondary light (=background radiation) in the waverange of the emission radiation, as well as the rapid decay of light energy over time.

For this reason the detector must be shielded against the short flash of light generated upon excitation, while on the other hand it should have high sensitivity. These necessities demand a measuring device with a very fast shutter or optical switch-on/off element for the detector, and a filter system with maximum possible transmission.

Conventional systems use mechanical shutters with their respective timing inaccuracies, and filter techniques with comparatively low transmission values.

By comparison, the solution according to the invention with an amplitude-modulated AOTF as narrow-band filter features an “electronic” shutter with a negligible jitter of less than 1 μsec and considerably higher transmission values (depending on the crystal material used) than ordinary filters (interference or diffraction gratings).

Both features add to the stability and sensitivity of the measuring processes. Due to the excellent properties of the AOTF as a shutter the beginning and end of the measuring cycle may be precisely determined.

Polarization Fluorescence

In this case molecular motion in the medium is of interest. This motion will lead to a depolarization of the emission radiation m. The sample 10 is excited by polarized light, and the two orthogonally positioned polarization planes A1 and A2 of the emission radiation are measured. From the ratio of the two measurements (detector 16 and 18) depolarization may be computed in the evaluation unit 25.

In conventional filter systems with interference filters or diffraction gratings either mechanically actuated polarization filters are inserted on either end of the light beam, or polarizers are placed at the input end of two optical fiberguides (with extra-small diameters).

The solution with AOTF proposed by the invention relies on the fact that the two polarization planes are already split up in the crystal, exiting therefrom as separate signals. Both signals are detected simultaneously by means of separate measuring systems and processed accordingly.

Thus the severe constraints presented by mechanical switching of the polarization filters is eliminated.

### (2) Chemiluminescence

A chemical reaction in the measuring cell will deliver a flash of light (flash luminescence) or a slowly fading light signal (glow luminescence), whose intensity and duration depend on the concentration of the material(s) for which the sample is analyzed.

The light emitted by the chemical reaction is measured by the same method as described under the heading of Intensity Fluorescence. Since the sample is significantly altered by the chemical reaction, measurements cannot be repeated.

Multiple tests with a single sample have required a number of completely separate test runs to date. Due to the use of frequency and/or amplitude modulated AOTF the invention will now permit rapid analysis of several different wavelengths within the time taken by the chemical reaction.

### (3) Absorption

A chemical reaction in the sample will have its effects on the absorption properties at a certain wavelength characteristic of the material.

The wavelength-selected light is passed through the sample and more or less absorbed by it depending on the degree of color change of the sample. The amount of light transmitted is measured and usually expressed as absorption on a logarithmic scale. By performing simultaneous reference measurements in waveranges that are insensitive to the reactions (optically effective) artefacts may be suppressed.

In summary, the measuring device in accordance with the invention is characterized by the following advantages:

Switching between the required wavelengths in the radiation path of excitation and/or emission radiation is effected purely electrically in the μsec range, thus being faster by some orders of magnitude than with the use of mechanical systems.

A plurality of wavelengths may be measured simultaneously or in rapid succession.

By frequency modulation or integration over several wavelengths the bandwith of the filter may be set or varied.

By drastically reducing the time for a change of wavelength, three-dimensional measurements (e.g., of the variables energy or intensity, excitation or emission wavelength, time duration) may be performed easily for all measuring processes described.

Due to the optical switching properties of the AOTF described it will be possible in fluorescence measuring processes to modulate or chop the excitation radiation of a constant light source, thus minimizing or suppressing bleaching and quenching effects.

Due to this switching property and the fact that extremely short flashes may be generated with a constant light source, expensive flashlights (such as a Xenon flashlight) may be dispensed with. Moreover, no special power supplies for such a flashlight will be required, which might cause problems regarding electromagnetic compatibility (EMC).

Due to the orthogonally polarized extraordinary beams of an AOTF it will be possible in fluorescence measuring to analyze both polarization planes simultaneously in a simple manner (without mechanical or electric switching).

AOTF have great operating reliability due to the lack of mechanically movable components, and are resistant to contamination due to their compact fitting.

AOTF have a longer life than mechanically movable components, and are insensitive to atmospheric humidity etc., if correctly fitted.

AOTF have high transmissions compared to diffraction gratings and interference filters, if suitable crystals are selected.

What is claimed is:

1. Method for determining at least one luminescence, fluorescence, or absorption parameter of a sample, comprising an excitation radiation supplied by a radiation source being directed onto said sample and an emission radiation emitted by said sample being detected by a detector unit, wherein at least one of said excitation radiation and said emission radiation is passed through an acousto-optical tunable filter (AOTF), wherein an excitation frequency of said acousto-optical filter is amplitude-modulated, applying an amplitude modulation in the form of a rectangular, Gaussian, Hann, or Hamming window to said excitation frequency in order to obtain an optical switch with switching times in a μsec range.

2. Method according to claim 1, wherein the bandwidth of said acousto-optical filter is set by a frequency modulation of said excitation frequency.

3. Method according to claim 1, wherein the bandwidth of said acousto-optical filter is varied by a frequency modulation of said excitation frequency

4. Method according to claim 1, wherein the intensities of two extraordinary beams of said acousto-optical filter positioned in said emission radiation, which are polarized orthogonally relative to each other, are simultaneously measured and a depolarization of said emission radiation is computed from a ratio of said intensities.

5. Measuring device for determining at least one luminescence, fluorescence, or absorption parameter of a sample, comprising an excitation light source supplying excitation radiation directed onto said sample, a detector unit for detection of the emission radiation emitted by said sample, and an acousto-optical tunable filter (AOTF) being provided in at least one radiation path of said excitation radiation and said emission radiation, wherein ultrasonic oscillations of said acousto-optical filter are excited by a high-frequency oscillator comprising a unit for amplitude modulation to provide an optical switch with switching times in a μsec range.

6. Measuring device according to claim 5, wherein said amplitude modulation is in the form of a rectangular window.

7. Measuring device according to claim 5, wherein said amplitude modulation is in the form of a Gaussian window.

8. Measuring device according to claim 5, wherein said amplitude modulation is in the form of a Hann window.

9. Measuring device according to claim 5, wherein said amplitude modulation is in the form of a Hamming window.
